(19) United States
(12) Patent Application Publication
(10) Pub. No.: US 2005/0081216 A1
(43) Pub. Date: Apr. 14, 2005

(54) Method, system, and program for calling a target object from a caller object

(75) Inventor: Brandon E. Taylor, Longmont, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sun Microsystems,Inc.

(21) Appl. No.: 10/682,660

(22) Filed: Oct. 8, 2003

(51) Int. Cl. G06F 9/44

(52) U.S. Cl. 719/315

(57) ABSTRACT

Provided are a method, system, and program for calling a target object from a caller object in a first call mode. A program component is invoked in response to the caller object initiating the call to the target object and the program component invokes execution of the call on the target object. The program component monitors the execution of the call on the target object and determines whether the execution of the call on the target object exceeds a threshold. The caller object is notified to cause the caller object to change from the first call mode to a second call mode in handling the call if the execution of the call is determined to exceed the threshold.

### BACKGROUND OF THE INVENTION

1. Field of the Invention

The present invention relates to a method, system, and program for calling a target object from a caller object

2. Description of the Related Art

A program can issue a call to an object or another program either synchronously or asynchronously. With a synchronous call, an application initiates a request to a target and the calling thread would block processing any further requests until a response or return value is received from the called target object or program. If the called target is unable to respond or delays responding, then the thread initiating the synchronous call will have to wait until a response is received and would have to block any additional client requests. Such blocking may be observed with a user interface program that receives input from a user. When the user interface issues a synchronous call in response to user input, the user may experience a delay that requires them to wait before any further action is allowed. Any further action in the user interface may be inhibited until the synchronous response is received.

In asynchronous communication, the calling thread will not wait or delay any further processing until the result is received. Instead, on initiating the asynchronous call, the caller application can proceed with further operations while waiting for a response from the called target.

Although asynchronous processing can improve application throughput and avoid delays in further processing, programmers often utilize synchronous calls because of the added complexity in using asynchronous processing. Further, synchronous calls allow for a tighter coupling of communication between the caller and the target.

### SUMMARY OF THE EMBODIMENTS

Provided are a method, system, and program for calling a target object from a caller object in a first call mode. A program component is invoked in response to the caller object initiating the call to the target object and the program component invokes execution of the call on the target object. The program component monitors the execution of the call on the target object and determines whether the execution of the call on the target object exceeds a threshold. The caller object is notified to cause the caller object to change from the first call mode to a second call mode in handling the call if the execution of the call is determined to exceed the threshold.

In further implementations, the first call mode comprises a synchronous mode and the second call mode comprises an asynchronous mode.

Still further, any return value from the called target object may be stored in a future object if the execution of the call on the target object exceeds the threshold.

In yet further implementations, the caller object invokes the call by calling a proxy object, and wherein the program component is invoked by the proxy object.

Still further, the program component may execute in a first thread and a second thread may be spawned to execute the call on the target object invoked by the component object.

### BRIEF DESCRIPTION OF THE DRAWINGS

Referring now to the drawings in which like reference numbers represent corresponding parts throughout:

FIG. 1 illustrates a computing environment and component interaction in accordance with certain implementations of the invention;

FIGS. 2, 3, and 4 illustrate operations to process a call to a target in accordance with implementations of the invention; and

FIG. 5 illustrates a computer architecture in which aspects of the invention may be implemented.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

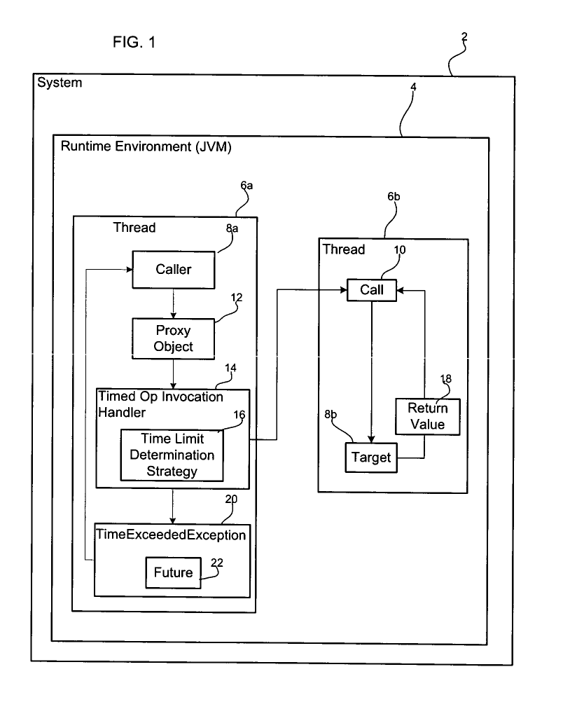

FIG. 1 illustrates a computing environment in which aspects of the invention are implemented. A system 2 includes a runtime environment 4, such as the Java** runtime environment. (Java is a trademark of Sun Microsystems, Inc.) FIG. 1 shows two threads 6a, 6b allocated in the runtime environment 4 to execute program components. Component objects, referred to as caller 8a and target 8b, are accessible using methods from classes loaded into the runtime environment from class files. FIG. 1 illustrates caller 8a invoking a method “call” 10, which is called on target 8b, wherein the invoked call 10 is declared by an interface of the target 8b.
**Sun Microsystems and Java are trademarks of Sun Microsystems, Inc.

FIG. 1 illustrates the flow of operations among program components that occurs when the caller 8a makes a call 10 on target object 8b. The caller 8a may synchronously invoke the method call 10 by making a call, that would have zero or more objects as parameters, to a dynamic proxy 12. The dynamic proxy 12 would maintain a reference to an invocation handler 14, referred to as the timed operation invocation handler. The caller 8a invokes the call 10 on the dynamic proxy 12 as if the dynamic proxy 12 is the target 8b itself. The dynamic proxy 12 exposes the same set of interfaces as the target 8b does. In response, the proxy object 12 invokes the invocation handler 14, which makes the call 10 on the target 8b. The invocation handler 14 is responsible for dispatching the operations invoked by the caller 8a in a manner that monitors the call to ensure that the call 10 operations complete within an allotted time determined by the time limit determination strategy 16, which may comprise a constant duration, e.g., thirty seconds. The caller 8a, dynamic proxy object 12, and timed operation invocation handler 14 all execute in thread 6a. The invocation handler 14 dispatches the invoked call 10 in a thread 6b other than thread 6a, whereby the invocation handler 14 may spawn thread 6b to execute the call 10. The target 8b may execute on the spawned second thread 6b or a thread may be spawned to execute the target 8b. The invocation handler 14 then monitors the execution time of the call 10 operation. If the operation completes within the allotted time as determined by the time limit determination strategy 16, then the invocation handler 14 returns any return value 18 directly to the caller 8a, appearing to the caller 8a as a typical request/response. The return value 18 may comprise a status, state, value, a vector of values, or any other return data known in the art. If the operation does not complete within the allotted time according to the time limit determination strategy 16, then the handler 14 will throw an unchecked TimeExceededException 20, indicating the situation to the caller 8a.

Thus, the caller 8a is notified when the TimeExceededException 20 is thrown so that the caller 8a will handle the call in an asynchronous manner. In asynchronous mode, the caller 8a will allow additional operations to proceed and continue to check the Future object 22 for a return value 18, using methods on the Future object 22. If the caller 8a presents information to a user interface, then the caller 8a may render some graphic indicating a wait state, such as an hour glass or progress bar until the return value 18 is retrieved from the Future object 22. During this wait state, the caller 8a may allow the execution of additional concurrent operations to proceed while waiting for a return value from the target object 8b. There may be methods defined to access the Future object 22, such as a GET method to get any return value 18 buffered in the Future object 22 and one method to return a true or false value indicating whether the return value 18 has been buffered in the Future object 22.

The TimeExceededException 20 may comprise an unchecked exception that indicates that the execution time of an operation has exceeded a maximum as determined by the time limit determination strategy 16. The TimeExceededException 20 encapsulates a Future object 22 that is used to represent the results of the operation performed by the target 8b in response to the call 10. Once the exception 20 is thrown, the caller 8a can continue to execute asynchronously with respect to the call 10. The Future object 22 will encapsulate the return value 18 when it becomes available. The caller 8a can use the Future object 22 to access any result value 18 of the operation when it is ready. The caller 8a may utilize blocking (timed or untimed) or non-blocking semantics to access the result value 18 from the Future object 22. Timed blocking allows the client to specify a wait time; when this wait time is exceeded, the client is notified (usually by an exception) and unblocked. In untimed blocking, the client waits indefinitely (i.e. stays blocked until the return value is available).

In certain implementations, the time limit determination strategy 16 may indicate a maximum wait time, such as several seconds that applies for all synchronous calls. In alternative implementations, other techniques may be used to determine the wait time. For example, the invocation handler 14 could read and parse a file, such as an Extensible Markup Language (XML) file, indicating time limits for different synchronous calls 10. This would allow the time limits to be “coded” using declarative rather than imperative techniques and to be varied across calls. Other simple, i.e., single time limit used for all calls, or sophisticated time limit determination strategies may also be used. A sophisticated strategy may be limited only by what can be expressed using the programming language, and may allow for different time limits for different calls or different time limits used at different times.

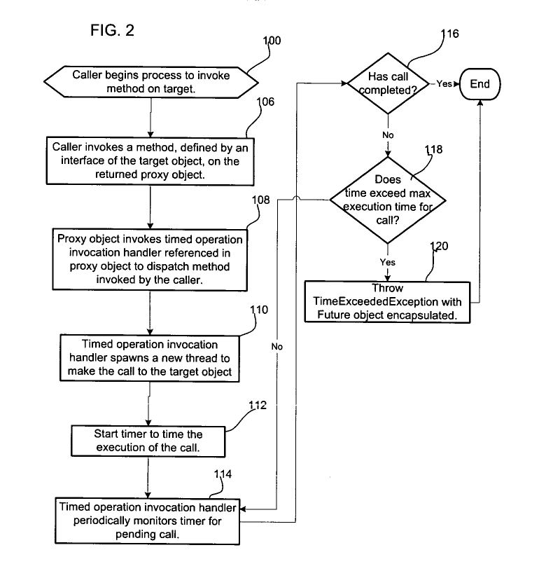

FIGS. 2, 3, and 4 illustrates operations performed by the components shown in FIG. 1 to execute a synchronous call 10 from the caller 8a to the target 8b. With respect to FIG. 2, the caller 8a begins (at block 100) the process to invoke the call 10 on the target 8b. Prior to the call being made, the dynamic proxy object 12 would have been created and made available for use by callers 8a. The dynamic proxy object 12 maintains a reference to the timed operation invocation handler 14, where the invocation handler 14 has a reference to the target 8b. The creation and return of the dynamic proxy object 12 occurs before the caller 8a invokes the call 10. The caller 8a would then invoke (at block 106) the call 10 by calling the proxy object 12. In response, the proxy object 12 would invoke (at block 108) the timed operation invocation handler 14 referenced in the proxy object 12 to dispatch the call 10 invoked by the caller 8a.

Upon being invoked on the thread 6a, the timed operation invocation handler 14 would spawn (at block 110) a new thread 6b to execute the call 10 to the target object 8b. The timed operation invocation handler 14, executing on thread 6a, would start (at block 112) a timer to time the execution of the call 10 on thread 6b. The call made from the caller 8a to the dynamic proxy 12 is different than the call made from the invocation handler 14 to the target 8b. At block 114, the invocation handler 14 periodically monitors (at block 114) the timer for the call 12 executing on thread 6b. In alternative implementations, the handler 14 will not periodically monitor (i.e. poll) the timer and instead use a timer that notifies the invocation handler 14 when the time is exceeded. As discussed, the time limit determination strategy 16 may provide a single maximum time for the execution of a call 10 to be pending, or different times for different call operations. In certain implementations, a separate timer may be maintained for each call spawned by a timed operation invocation handler 14. If (at block 116) the execution of the call 10 has completed, then control ends. Otherwise, if the call 10 is pending and if (at block 118) the timer exceeds the maximum time of execution for the call 10 indicated in the time limit determination strategy 16, then the invocation handler 14 throws (at block 120) the TimeExceededException 20 encapsulating the Future object 22. When throwing the exception 20, the invocation handler 14 would notify the caller 8a, which would cause the caller 8a to handle the call in an asynchronous mode as opposed to synchronous mode, as described with respect to FIG. 4. If (at block 118) the maximum time is not exceeded, then control proceeds back to block 114 where the timed operation invocation handler 14 continues to periodically monitor whether the call 10 has exceeded a maximum time limit.

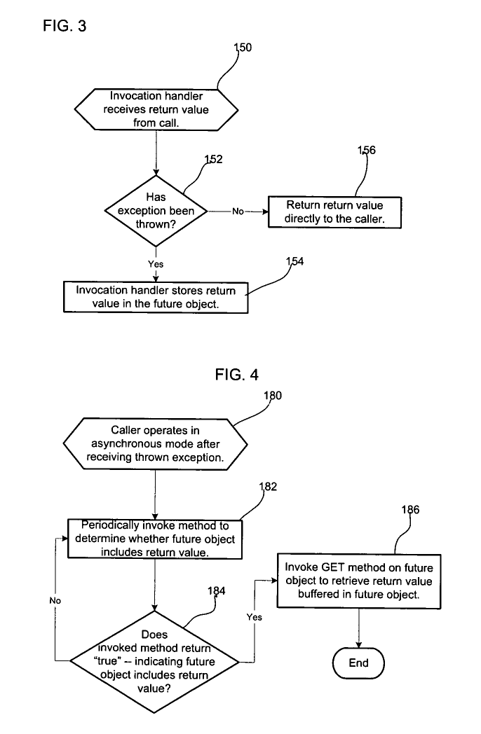

FIG. 3 illustrates operations performed by the invocation handler 14 to handle return values 18 returned from the target object 8b. Upon the invocation handler 14 receiving (at block 150) the return value 18 from the call 10 executing on thread 6b, if (at block 152) the exception 20 was thrown, then the invocation handler 14 stores (at block 154) the return value 18 in the Future object 22 when the return value 18 becomes available. Otherwise, if no exception 20 was thrown, then the return value 18 is sent (at block 156) directly to the caller 8a.

FIG. 4 illustrates operations performed by the caller 8a operating in asynchronous mode after receiving notification of the TimeExceededException 20. When operating (at block 180) in asynchronous mode, the caller 8a periodically invokes (at block 182) a method to call on the Future object 22 to determine whether the return value 18 is yet available. This method may return “true” indicating that the return value 18 is available or “false” indicating that the return value 18 is not yet available. If (at block 184) the invoked method returns “true”, indicating that the Future object 22 includes the return value 18, then the caller 8a invokes (at block 186) a GET method on the Future object 22 to retrieve the return value 18 buffered therein. Otherwise, if (at block 184) the method returns “false”, then control proceeds back to block 182 where the caller 8a continues to monitor whether the return value is available in the Future object 22. Alternatively, the caller 8a can use a blocking GET method. In certain situations, the return value 18 may be an exception if the target 8b is successfully called and throws an exception.

With the described implementations, the caller 8a may initially attempt a synchronous type call. However, if the target is delayed beyond an unacceptable maximum time limit, then the mode may be switched to asynchronous where the caller 8a will have to obtain the return value 18 from the Future object 22 encapsulated within the exception 20. In this way, those called operations taking longer than the allotted maximum time, according to a time limit determination strategy, are handled differently than those operations that complete within the allotted time. Once the asynchronous mode is initiated, then the caller 8a may allow continued operations to be performed. For instance, a user interface caller may allow the user to initiate further operations and concurrently periodically check on the return value. This avoids the situation that would occur with a synchronous call, which would prevent any further action on the calling thread until a response is received.

The above described method, apparatus or article of manufacture for handling method calls may use standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which described implementations are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The described implementations utilized the Java programming language. Alternatively, the implementations may utilize other object oriented programming languages, such as C++, Smalltalk, etc.

In the described implementations, an invocation handle and exception were used to monitor the time taken by the call and alert the caller of a change in mode from synchronous to asynchronous. In alternative implementations, different programming techniques and program components may be used to monitor the execution time of the call and alert the caller to change from synchronous to asynchronous mode processing.

The caller 8a and target 8b may be located in the same address space, e.g., a same Java Virtual Machine (JVM), or different address spaces, JVMs, on the same or different systems. If the caller 8a and target 8b are in different address spaces, then they may use a remote call protocol such as the Remote Method Invocation (RMI) to communicate calls from the caller 8a to target. In such implementations where the caller and target are in different address spaces, the dynamic proxy and invocation handler may operate in the address space, e.g., JVM, of the caller.

In described implementations, the Future object 22 is encapsulated in the exception. In alternative implementations, the Future object 22 may comprise a variable or buffer located anywhere in the system.

The time limit determination strategy 16 may be modified by a user to indicate a maximum time limit to use for all calls or different time limits for different calls.

In the described implementations, the caller initially makes a synchronous call and is notified to operate in asynchronous mode if the time limit of the call execution is exceeded. In alternative implementations, the caller may initiate the call in a mode other than synchronous, such as asynchronous, and be notified to switch to a mode other than asynchronous.

FIGS. 2, 3, and 4 illustrate specific operations occurring in a particular order. In alternative implementations, certain of the logic operations may be performed in a different order, modified or removed and still implement the present invention. Moreover, steps may be added to the above described logic and still conform to the described implementations. Further, operations described herein may occur sequentially or certain operations may be processed in parallel. Yet further, operations described herein may be performed by a single process and/or processing unit or distributed among a plurality of processes and/or processing units.

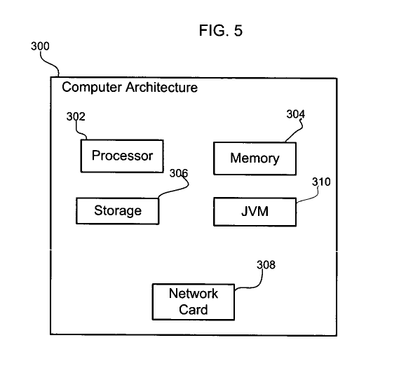

FIG. 5 illustrates one implementation of the system architecture of the system 2 (FIG. 1). The system 2 may implement a computer architecture 300 having a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes a network card 308 to enable communication with a network. Further, in certain implementations, the architecture may include a virtual machine program, such as the Java Virtual Machine (JVM) 310.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method for calling a target object from a caller object in a first call mode, comprising:
invoking a program component in response to the caller object initiating the call to the target object;
invoking, with the program component, execution of the call on the target object;
monitoring, with the program component, the execution of the call on the target object;
determining, with the program component, whether the execution of the call on the target object exceeds a threshold; and
notifying the caller object to cause the caller object to change from the first call mode to a second call mode in handling the call if the execution of the call is determined to exceed the threshold.

2. The method of claim 1, wherein the first call mode comprises a synchronous mode and the second call mode comprises an asynchronous mode.

3. The method of claim 1, wherein determining whether the execution of the call on the target object exceeds the threshold comprises determining whether the call has been executing for a maximum period of time.

4. The method of claim 3, wherein a data object maintains different maximum period of times for different calls, and wherein determining whether the execution of the call on the target object has been executing for the maximum period of time further comprises determining from the data object the maximum period of time corresponding to the invoked call to use to determine whether the maximum period of time has been exceeded.

5. The method of claim 1, further comprising:
storing any return value from the called target object in a future object if the execution of the call on the target object exceeds the threshold.

6. The method of claim 5, further comprising:
returning the return value from the target object to the caller object if the execution of the call on the target object does not exceed the threshold.

7. The method of claim 5, further comprising:
periodically querying with the caller object the future object after receiving the notification from the program component to determine when the return value is available in the future object; and
accessing the return value from the future object after determining that the return value is available in the future object.

8. The method of claim 1, wherein the caller object invokes the call by calling a proxy object, and wherein the program component is invoked by the proxy object.

9. The method of claim 8, wherein the program component comprises an invocation handler, further comprising:
throwing an exception, by the invocation handler, when determining that the execution of the call on the target object exceeds the threshold, wherein the caller is notified through the thrown exception.

10. The method of claim 1, wherein the program component executes in a first thread, further comprising:
spawning a second thread to execute the call on the target object invoked by the component object.

11. A system, comprising:
a processor;
a computer readable memory;
a target object and a caller object implemented in the memory by the processor;
program code executed by the processor to cause the processor to perform:
(i) invoking a program component in response to the caller object initiating a call to the target object in a first call mode;
(ii) invoking, with the program component, execution of the call on the target object;
(iii) monitoring, with the program component, the execution of the call on the target object;
(iv) determining, with the program component, whether the execution of the call on the target object exceeds a threshold; and
(v) notifying the caller object to cause the caller object to change from the first call mode to a second call mode in handling the call if the execution of the call is determined to exceed the threshold.

12. The system of claim 11, wherein the first call mode comprises a synchronous mode and the second call mode comprises an asynchronous mode.

13. The system of claim 11, wherein determining whether the execution of the call on the target object exceeds the threshold comprises determining whether the call has been executing for a maximum period of time.

14. The system of claim 13, further comprising:
a data object in the computer readable medium maintaining different maximum period of times for different calls, and wherein determining whether the execution of the call on the target object has been executing for the maximum period of time further comprises determining from the data object the maximum period of time corresponding to the invoked call to use to determine whether the maximum period of time has been exceeded.

15. The system of claim 11, wherein the program code is executed to cause the processor to further perform:
storing any return value from the called target object in a future object if the execution of the call on the target object exceeds the threshold.

16. The system of claim 15, wherein the program code is executed to cause the processor to further perform:
returning the return value from the target object to the caller object if the execution of the call on the target object does not exceed the threshold.

17. The system of claim 15, wherein the program code is executed to cause the processor to further perform:
periodically querying with the caller object the future object after receiving the notification from the program component to determine when the return value is available in the future object; and
accessing the return value from the future object after determining that the return value is available in the future objec

18. The system of claim 11, further comprising:
a proxy object in the computer readable medium, wherein the caller object invokes the call by calling the proxy object, and wherein the program component is invoked by the proxy object.

19. The system of claim 18, wherein the program component comprises an invocation handler, and wherein the program code is executed to cause the processor to further perform:
throwing an exception, by the invocation handler, when determining that the execution of the call on the target object exceeds the threshold, wherein the caller is notified through the thrown exception.

20. The system of claim 11, wherein the program component executes in a first thread, wherein the program code causes the processor to further perform:
spawning a second thread to execute the call on the target object invoked by the component object.

21. An article of manufacture for calling a target object from a caller object in a first call mode, wherein the article of manufacture causes operations to be performed, the operations, comprising:
invoking a program component in response to the caller object initiating the call to the target object;
invoking, with the program component, execution of the call on the target object;
monitoring, with the program component, the execution of the call on the target object;
determining, with the program component, whether the execution of the call on the target object exceeds a threshold; and
notifying the caller object to cause the caller object to change from the first call mode to a second call mode in handling the call if the execution of the call is determined to exceed the threshold.

22. The article of manufacture of claim 21, wherein the first call mode comprises a synchronous mode and the second call mode comprises an asynchronous mode.

23. The article of manufacture of claim 21, wherein determining whether the execution of the call on the target object exceeds the threshold comprises determining whether the call has been executing for a maximum period of time.

24. The article of manufacture of claim 23, wherein a data object maintains different maximum period of times for different calls, and wherein determining whether the execution of the call on the target object has been executing for the maximum period of time further comprises determining from the data object the maximum period of time corresponding to the invoked call to use to determine whether the maximum period of time has been exceeded.

25. The article of manufacture of claim 21, further comprising:
storing any return value from the called target object in a future object if the execution of the call on the target object exceeds the threshold.

26. The article of manufacture of claim 25, further comprising:
returning the return value from the target object to the caller object if the execution of the call on the target object does not exceed the threshold.

27. The article of manufacture of claim 25, further comprising:
periodically querying with the caller object the future object after receiving the notification from the program component to determine when the return value is available in the future object; and
accessing the return value from the future object after determining that the return value is available in the future object.

28. The article of manufacture of claim 21, wherein the caller object invokes the call by calling a proxy object, and wherein the program component is invoked by the proxy object.

29. The article of manufacture of claim 28, wherein the program component comprises an invocation handler, further comprising:
throwing an exception, by the invocation handler, when determining that the execution of the call on the target object exceeds the threshold, wherein the caller is notified through the thrown exception.

30. The article of manufacture of claim 21, wherein the program component executes in a first thread, further comprising:
spawning a second thread to execute the call on the target object invoked by the component object.
